(19) United States
(12) Patent Application Publication
(10) Pub. No.: US 2006/0289191 A1
(43) Pub. Date: Dec. 28, 2006

(54) Disk device

(75) Inventor: Katsushi Yamashita, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/474,443

(22) Filed: Jun. 26, 2006

(30) Foreign Application Priority Data
Jun. 28, 2005 (JP) 2005-187651

(51) Int. Cl. H02G 3/08

(52) U.S. Cl. 174/50

(57) ABSTRACT

The invention provides a shield case of a disk device for shielding electromagnetic noises irradiated from a circuit board of a disk device, which can be downsized. A shield case 15 is divided into two parts, a first shield case 15A and a second shield case 15B. While enclosing the whole body of the circuit board 6 therein, the shield case 15 is fixed horizontally to the upper surface of the frame 7. The electromagnetic noises irradiated from the circuit board 6 are shielded by the shield case 15. By covering the circuit board 6 with the shield case 15 for shielding electromagnetic noises, the shield case 15 can be downsized as a compact component, and thus a disk device 1 to which the shield case 15 is assembled can also be downsized.

The present application is based on and claims priority of Japanese patent application No. 2005-187651 filed on Jun. 28, 2005, the entire contents of which are hereby incorporated by reference.

### BACKGROUND OF THE INVENTION

1. Field of the Invention

The present invention relates to a disk device for recording and/or reproducing data on a disk by irradiating laser beams on a recording surface of the disk, and more specifically, to a disk device capable of effectively suppressing the electromagnetic noises generated from a circuit board controlling the disk device.

2. Description of the Related Art

In recent years, disk devices such as DVD reproducing apparatuses and the like are not only used alone but also assembled into television receivers with built-in disk devices, and the areas of use thereof are expanding. Such DVD reproducing apparatuses process digital image signals in order to reproduce moving images, during which electromagnetic noises are irradiated from circuit boards such as an MPEG (moving picture experts group) board controlling the DVD reproducing apparatus, and especially in a composite television receiver with a built-in disk device, the electromagnetic noises irradiated from the circuit board (MPEG board) enter the television circuit or the like and provide negative effects on the apparatus. Therefore, it is very important to provide measures against such electromagnetic noises.

One example of such measures to cope with noises in a disk device is disclosed in Japanese utility model registration No. 3095551 (patent document 1), disclosing a shield structure of a disk device composed of a front panel made of resin, a rear panel made of metal, an upper case made of metal and a lower case made of metal to be used in a stand-alone disk device in which the disk device is used alone. In such a stand-alone disk device, the casing of the disk device functions as a shield case for shielding noise, but in a composite apparatus such as a television receiver with a built-in disk device, the electromagnetic noise irradiated from the circuit board (MPEG board) for processing digital image signals to produce moving images will enter and negatively effect other circuits such as the television circuit. Regarding such composite television receiver with a built-in disk device, Japanese utility model registration No. 3075808 (patent document 2) discloses a television with a built-in DVD reproducing apparatus arranged so that the whole body of the DVD reproducing apparatus housed in a casing of the television receiver is covered with a shield base and a shield cover so as to shield the electromagnetic noises irradiated from the DVD reproducing apparatus.

The television with a built-in DVD reproducing apparatus disclosed in patent document 2 encloses the whole body of the DVD reproducing apparatus housed in the casing with the shield base and the shield cover, so the size of the shield case for shielding the electromagnetic noise is enlarged. However, in the field of composite machines in which DVD reproducing apparatuses and television receivers or the like are stored in a single casing, there is a trend to downsize the whole body of the composite apparatus by assembling the components with high density in the casing, so there is a drawback in adopting the prior art shield structure in which the whole body of the DVD reproducing apparatus is enclosed in a large shield case, since it causes increase in size of the apparatus.

### SUMMARY OF THE INVENTION

The present invention aims at solving the problems of the prior art by providing a disk device capable of downsizing the shield case for shielding the electromagnetic noises irradiated from the circuit board and minimizing the mounting space for mounting the shield case.

Aspect 1 of the present invention relates to a disk device comprising a turntable for rotating a disk, a damper opposed to the turntable and holding the disk therebetween, a pickup lens for irradiating a laser beam to a recording surface of the disk, a circuit board for controlling the disk device, and a frame to which the components are assembled, wherein the disk is moved from an exterior of the frame where the disk can be exchanged to an interior of the frame where the disk is opposed to the pickup lens for recording and reproducing data on the disk; wherein the frame comprises a pair of opposing side wall portions, and a supporting unit bridged between the two side wall portions and extended in the horizontal direction for fixing a driving system unit including the pickup lens, a transport mechanism thereof and a turntable; the disk device further comprising a shield case for enclosing the circuit board, the shield case being bridged between the side wall portions substantially in parallel with the supporting unit of the frame.

According to the arrangement of aspect 1, the electromagnetic noise irradiated from the circuit board is electromagnetically shielded by the shield case, by which the noise is suppressed from affecting other electronic devices. Furthermore, since the shield case enclosing the circuit board is bridged between the side wall portions substantially in parallel with the supporting unit of the frame, the shield case including the circuit board can be fixed using the mounting space of the frame.

Aspect 2 of the present invention relates to a disk device according to aspect 1, wherein the shield case is fixed to the frame so as to cover either an upper area or a lower area of the driving system unit.

According to the arrangement of aspect 2, the upper area or the lower area of the driving system unit fixed to the frame can be covered by the shield case of the circuit board, and the electromagnetic noise irradiated from the driving system unit can also be reduced by the shield case.

Aspect 3 of the present invention relates to a disk device according to aspects 1 or 2, wherein the shield case is divided into a first shield case and a second shield case, further comprising a positioning means for positioning the first shield case and the circuit board to the frame, a first fixing means for fixing the frame and the circuit board, and a second fixing means for fixing the circuit board and the first shield case, the first and second fixing means fixing the circuit board and the first shield case to the frame, and the second shield case being fixed to the first shield case fixed to the frame, so that the first and second shield cases enclose the circuit board.

According to the arrangement of aspect 3, subsequent to positioning the first shield case to the frame via the positioning means, the circuit board is assembled to the first shield case so as to determine the position of the frame and the circuit board. The circuit board and the frame are fixed via the first fixing means, and via the second fixing means, the circuit board integrated with the frame and the first shield case are fixed. Thereby, the first shield case and the circuit board are integrally fixed to the frame, so that by fixing the second shield case to the first shield case fixed to the frame, the shield cases can be disposed so as to enclose the circuit board. Furthermore, by providing a first fixing means for fixing the frame and the circuit board, it becomes possible to omit the shield case and fix only the circuit board to the frame, enabling the circuit board to be fixed in an exposed manner on the frame. That is, the disk device can be used both in a stand-alone dedicated device being housed in a casing and in a composite machine in which the disk device is housed together with other devices such as television receivers in a casing, wherein in the case of a dedicated device, the casing for housing the disk device also functions as a shield case, so that the circuit board fixed in the casing in an exposed manner has little influence on other electronic devices. As described, the frame and the circuit board of the disk device can be used in common both in a dedicated stand-alone disk device in which the shield case can be omitted and in a composite machine assembled with other electronic devices.

### BRIEF DESCRIPTION OF THE DRAWINGS

FIG. 1 is an exploded perspective view of the shield case and the frame showing the first embodiment of the present invention;

FIG. 2 is a perspective view of the disk device having the shield case assembled thereto according to the same;

FIG. 3 is a plan view of the disk device with the shield case removed according to the same;

FIG. 4 is a cross-sectional view of the disk device according to the same;

FIG. 5 is a perspective view showing the state in which the circuit board is assembled to the disk device; and

FIG. 6 is a cross-sectional view showing the second embodiment of the present invention.

### DETAILED DESCRIPTION OF THE PREFERRED EMBODIMENTS

Now, the preferred embodiments of the present invention will be described with reference to the accompanying drawings. The preferred embodiments described below are mere examples for realizing the present invention, and they do not limit the scope of the present invention.

[Embodiment 1]

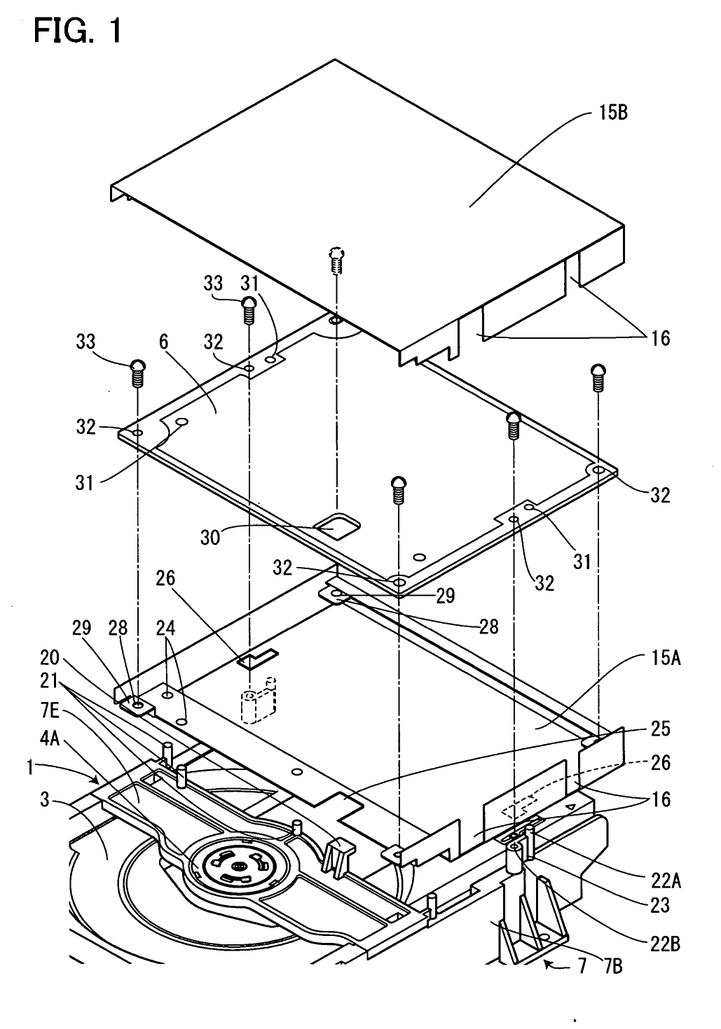

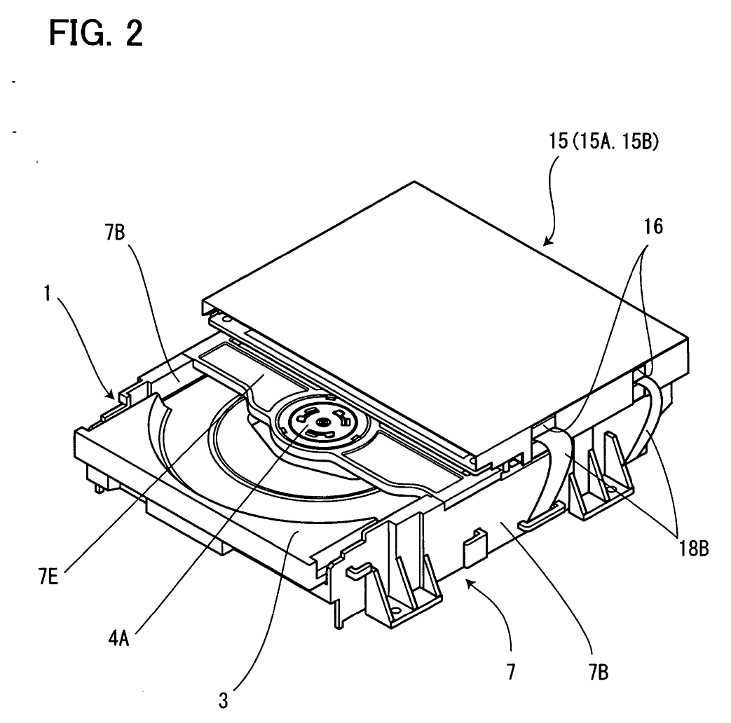

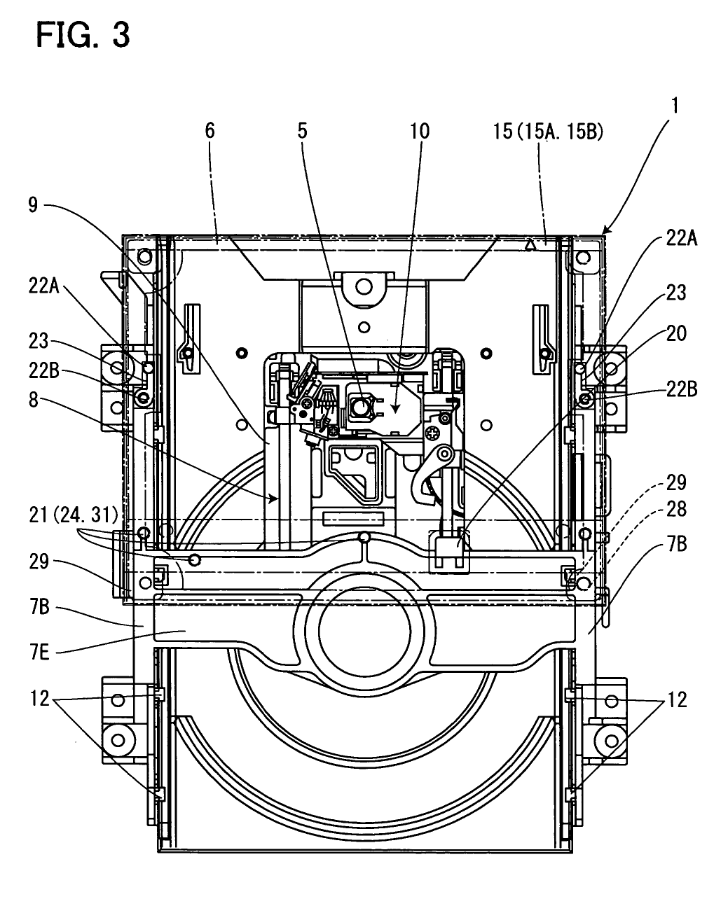

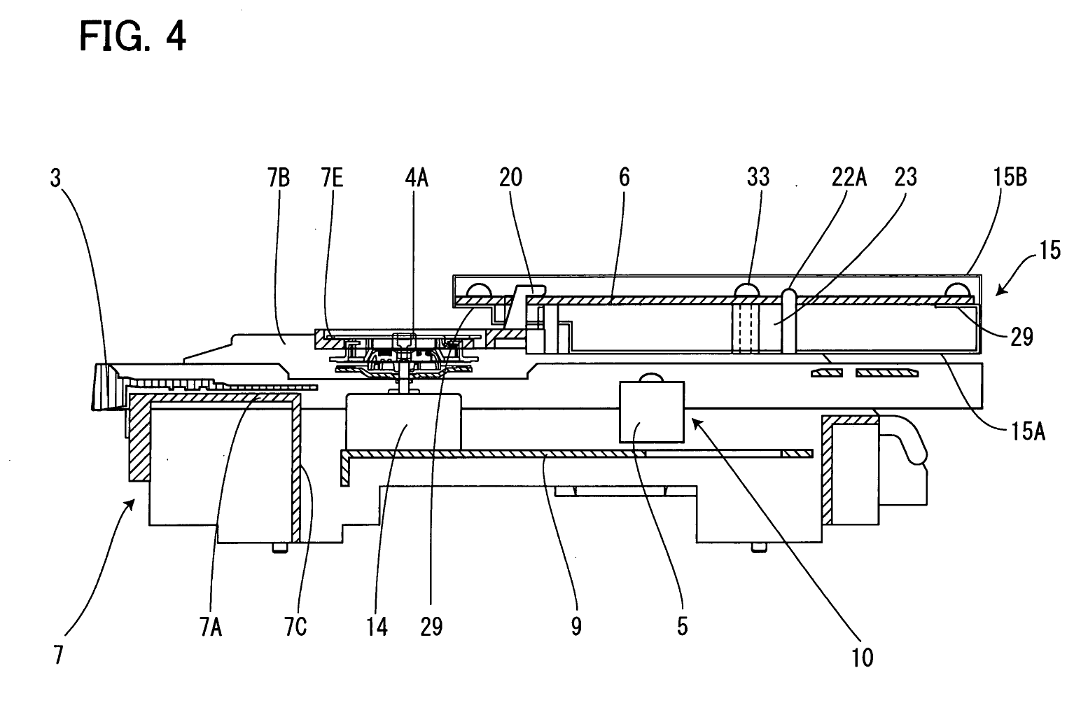

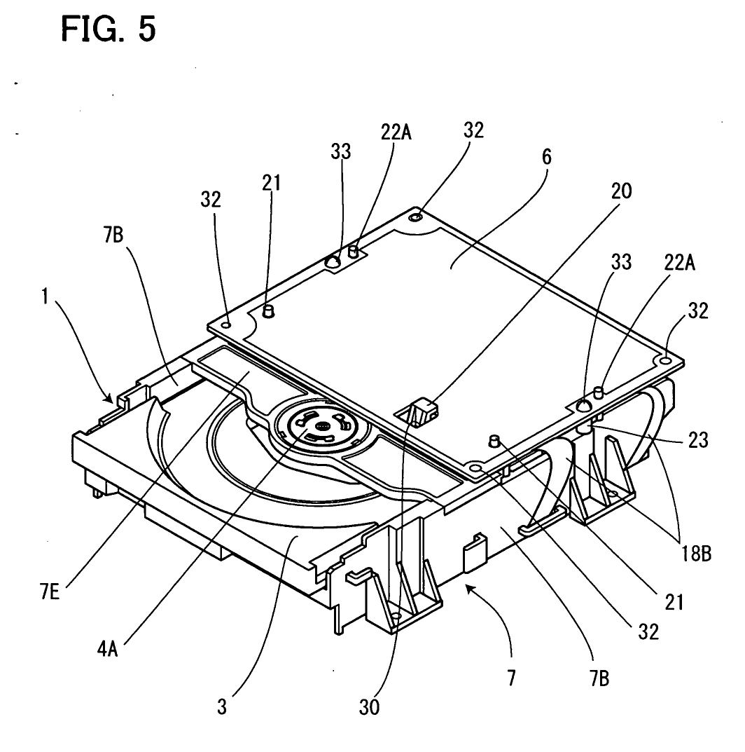

FIGS. 1 through 5 illustrate a first embodiment of the disk device according to the present embodiment, wherein FIG. 1 is an exploded perspective view of the shield case and the frame, FIG. 2 is a perspective view of the disk device having the shield case assembled thereto, FIG. 3 is a plan view of the disk device with the shield case removed, FIG. 4 is a cross-sectional view of the disk device, and FIG. 5 is a perspective view showing the state in which a circuit board is assembled to the disk device. As shown in FIGS. 1 through 5, the disk device 1 includes as main components a tray 3 for loading and ejecting a disk, a turntable 4 for rotating the disk, a damper 4A opposed to the turntable and holding the disk therebetween, a pickup lens 5 disposed so as to be able to move back and forth in the radial direction of the disk, and a circuit board 6 for controlling the disk device 1, wherein the main components are assembled to a frame 7 made of synthetic resin. Further, the turntable 4, the pickup lens 5 and its transport mechanism 8 are fixed to a metallic support frame 9 and formed as an integral unit, which is referred to as a driving system unit 10.

The frame 7 is composed of a support portion 7A extended in the horizontal direction and side wall portions 7B formed integrally to both left and right sides of the support portion 7A, having the driving system unit 10 exposed through an opening portion 7C formed to the support portion 7A and fixed thereto, and further having rails 12 formed on the inner sides of the side wall portions 7B for guiding the tray 3, so that the tray 3 is guided so as to be able to move back and forth with respect to the frame 7 along the rails 12.

The turntable 4 is driven to rotate via a spindle motor 14 disposed at substantially the center of the frame 7, and on the upper area of the turntable 4 is disposed a band plate-shaped supporting plate 7E integrally bridged between side wall portions 7B of the frame 7. At the center area of the supporting plate 7E is disposed a damper 4A, wherein the damper 4A and the turntable 4 hold the disk therebetween and rotate the disk.

A circuit board 6 is a control circuit board such as an MPEG (moving picture experts group) board for demodulating the video/audio signals read optically from the disk via the pickup lens 5, expanding the compressed video/audio signals and decoding the original video/audio signals, the whole body of which is enclosed in a metallic shield case 15. The shield case 15 for surrounding and enclosing the circuit board 6 is composed of a first shield case 15A and a second shield case 15B which are formed by dividing bent metallic plates into upper and lower parts, wherein the first shield case 15A is formed substantially as a flat panel as a whole with side panels disposed on both sides thereof, and the second shield case 15B is formed as a thin box-shaped member having surrounding wall portions hanging downward from the outer edges of a top panel portion with the lower area opened. The shield cases 15A and 15B have cutout portions 16 for allowing flexible flat cables having flexibility (hereinafter simply referred to as flat cables) 18B connected to the circuit board 6 to be passed therethrough, and via the flat cables 18B the circuit board 6 and the driving system unit 10 are electrically connected, and the video/audio signals optically read from the disk via the pickup lens 5 are demodulated in the video/audio signal processing circuit formed on the circuit board 6, where the compressed video/audio signals are expanded and decoded into the original video/audio signals.

The circuit board 6 and the shield case 15 housing the circuit board 6 are supported on and bridged between the upper surfaces of left and right side wall portions 7B of the frame 7 and fixed horizontally with respect to the frame 7. A supporting portion 7E of the frame 7 has an L-shaped engagement claw 20 formed integrally thereto for engaging the circuit board 6, and the side wall portions 7B and 7B of the frame 7 have multiple positioning pins 21 and ribs 23 with a positioning pin 22A and a fixing hole 22B. The first shield case 15A has formed thereto positioning holes 24 that correspond to the positioning pins 21, through holes 25 and 26 that correspond to the engagement claw 20 and ribs 23, and bent strips 29 having screw holes 28 for fixing the circuit board 6 positioned on the corners of the first shield case 15A. On the other hand, the circuit board 6 has formed thereto an engagement hole 30, positioning holes 31 and screw through holes 32 that respectively correspond to the engagement claw 20, the positioning pins 21 and the fixing holes 22B formed to the frame 7 and the screw holes 28 formed to the first shield case 15A. In other words, as the positioning means for positioning the first shield case 15A and the circuit board 6 to the frame 7, the frame 7 has an engagement claw 20, positioning pins 21 and 22A and ribs 23, the first shield case 15A has positioning holes 24 and through holes 25 and 26, and the circuit board 6 has an engagement hole 30 and positioning holes 31 formed respectively thereto. Moreover, fixing holes 22B are formed to the frame 7 as first fixing means for fixing the frame 7 and the circuit board 6, and bent strips 29 having screw holes 28 are formed to the corner portions of the first shield case 15A as second fixing means for fixing the circuit board 6 and the first shield case 15A.

According to the present embodiment arranged as described above, at first, the first shield case 15A is assembled to the frame 7. In other words, the positioning holes 24 and through holes 25 and 26 formed to the first shield case 15A are engaged with the positioning pins 21, the ribs 23 and the engagement claw 20 formed to the frame 7 so that the first shield case 15A is correctly positioned and supported on the frame 7. Then, the circuit board 6 is assembled to the first shield case 15A thus positioned on the frame 7. At this time, the engagement hole 30 formed to the circuit board 6 is inserted to the engagement claw 20 formed to the frame 7 and the circuit board 6 is slid frontward, and then the positioning holes 31 of the circuit board 6 are inserted to the positioning pins 21 on the frame 7 so that the circuit board 6 is correctly positioned and supported on the frame 7. Thereafter, screws 33 passed through the screw through holes 32 on the circuit board 6 are screw-engaged to fixing holes 22B of the ribs 23 to fix the circuit board 6 to the frame 7, and the screws 33 passed through the screw through holes 32 of the circuit board 6 are engaged to the screw holes 28 formed to bent strips 29 of the first shield case 15A so that the frame 7, the first shield case 15A and the circuit board 6 are mutually integrated. Thereafter, flat cables 18B are connected to the circuit board 6 and the second shield case 15B is arranged to cover the first shield case 15A, and then the two shield cases 15A and 15B are fixed via appropriate fixing means such as screws not shown. Thereby, the area around the circuit board 6 is enclosed via shield cases 15A and 15B, and the electromagnetic noises irradiated from the circuit board 6 are electromagnetically shielded via the shield case 15. Moreover, by having the shield case 15 enclosing the circuit board 6 bridged between side wall portions 7B and 7B of the frame 7, as shown in FIGS. 2 and 4, the shield case 15 covers the upper opening portion of the frame 7, by which the upper portion of the driving system unit 10 fixed to the frame 7 is covered by the shield case 15 housing the circuit board 6. Thereby, the shield case 15 enclosing the circuit board 6 can suppress the electromagnetic noises irradiated from the driving system unit 10.

The present embodiment having the arrangement described above encloses the circuit board 6 for processing digital image signals with the shield case 15, enabling the electromagnetic noises irradiated from the circuit board 6 to be effectively shielded by the shield case 15, and since only the circuit board 6 is enclosed in the shield case 15, the arrangement enables the shield case 15 to be downsized and reduced in weight compared to the arrangement in which the whole disk device 1 is shielded. Moreover, the shield case 15 is divided into upper and lower parts, wherein the first shield case 15A is provided with holes 24 and 25 for receiving the engagement claw 20 and ribs 23 formed to the frame 7 as positioning means for positioning the first shield case 15A to the frame 7 of the disk device 1, and after positioning the first shield case 15A to the frame 7, screws 33 are engaged to fixing holes 22B formed to the frame 7 to fix the circuit board 6 to the frame 7. As described, the circuit board 6 integrated with the frame 7 and the first shield case 15A are fixed by engaging screws 33 to screw holes 28 formed to bent strips 29 of the first shield case 15A. According to this arrangement, it is possible to omit the shield case 15 as illustrated in FIG. 5, and have the circuit board 6 fixed in an exposed manner to the frame 7 by inserting the engagement claw 20 and positioning pins 21 formed to the frame 7 to the engagement hole 30 and positioning holes 31 formed to the circuit board 6, then engaging screws 33 to the fixing holes 22B. That is, if the disk device 1 is not built into a composite machine but used as a single stand-alone unit, the housing for enclosing the disk device 1 will function as a shield case if the whole housing body (not shown) is made of metal, and there is little need to enclose the circuit board 6 in a shield case 15 to shield the same. Therefore, according to the arrangement enabling the first shield case 15A to be omitted and the circuit board 6 alone to be fixed to the frame 7 of the disk device 1, the frame 7 and the circuit board 6 of the disk device 1 can be used in common both in a composite machine such as a television receiver with a built-in disk device 1 and in a dedicated stand-alone disk device unit, so the present embodiment has advantageous versatility. Furthermore, by having the shield case 15 enclosing the circuit board 6 fixed horizontally to the frame 7 so as to cover the driving system unit 10 including the turntable 4, the pickup lens 5 and the transport mechanism 8 thereof formed as a unit, not only the electromagnetic noises irradiated from the circuit board 6 but also the electromagnetic noises irradiated from the driving system unit 10 can be shielded effectively. Moreover, the upper surface of the disk device 1 can be opened by removing the shield case 15 and the circuit board 6, so the adjustment of the pickup lens and the like can be facilitated.

[Embodiment 2]

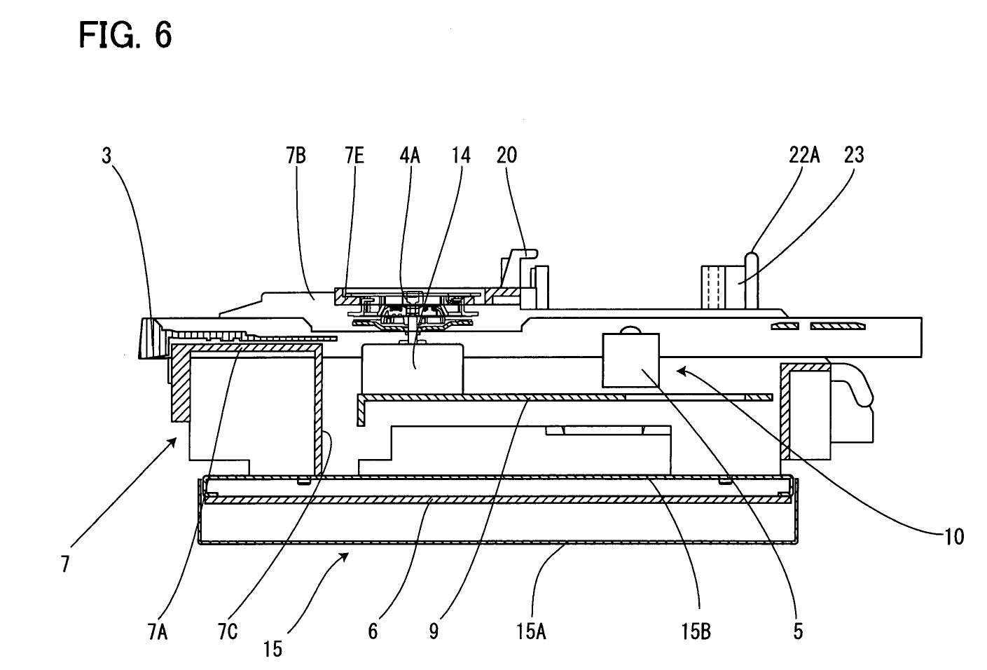

FIG. 6 is a cross-sectional view of the disk device illustrating the second embodiment of the present invention. In embodiment 2, the components having the same functions as embodiment 1 are denoted with the same reference numbers and the descriptions of the components common to embodiment 1 are omitted, and only the portions that differ are described.

Embodiment 1 discloses an example in which the shield case 15 housing the circuit board 6 is bridged over the upper surfaces of left and right side wall portions 7B of the frame 7 so as to cover the upper portion of the driving system unit 10 in which the turntable 4, the pickup lens 5 and the transport mechanism 8 thereof are assembled as a unit, but according to the present embodiment, the shield case 15 housing the circuit board 6 is extended between the lower surfaces of left and right side wall portions 7B of the frame 7 and fixed horizontally so as to cover the lower area of the driving system unit 10. As described, upon fixing the shield case 15 housing the circuit board 6 on the lower surface of the frame 7, a spacer should be disposed on the bottom portion of a casing (not shown) housing the disk device 1 so as to arrange the shield case 15 in the space formed between the bottom portion of the casing and the frame 7 by the spacer.

As described, by enclosing the circuit board 6 in the shield case 15, similarly as embodiment 1, the electromagnetic noise irradiated from the circuit board 6 can be effectively shielded by the shield case 15. Furthermore, by fixing the shield case 15 enclosing the circuit board 6 horizontally to the frame 7 so as to cover the lower area of the driving system unit 10 in which the turntable 4, the pickup lens 5 and the transport mechanism 8 thereof are formed as a unit, the electromagnetic noise irradiated downward from the driving system unit 10 can be shielded effectively.

The preferred embodiments of the present invention have been described in detail up to now, but the present invention is not limited to these embodiments, and various modifications are possible within the scope of the present invention. For example, the basic structures of the disk device such as the mounting structure of the circuit board and the positioning means are not limited to those illustrated in the embodiments, and they can be determined arbitrarily according to use.

The effects of the present invention are as follows.

The first aspect of the present invention provides a disk device comprising a turntable for rotating a disk, a damper opposed to the turntable and holding the disk therebetween, a pickup lens for irradiating a laser beam to a recording surface of the disk, a circuit board for controlling the disk device, and a frame to which the components are assembled, wherein the disk is moved from an exterior of the frame where the disk can be exchanged to an interior of the frame where the disk is opposed to the pickup lens for recording and reproducing data on the disk; wherein the frame comprises a pair of opposing side wall portions, and a supporting unit bridged between the two side wall portions and extended in the horizontal direction for fixing a driving system unit including the pickup lens, a transport mechanism thereof and a turntable; the disk device further comprising a shield case for enclosing the circuit board, the shield case being bridged between the side wall portions substantially in parallel with the supporting unit of the frame. According to this arrangement, the electromagnetic noise irradiated from the circuit board can be effectively shielded by the shield case, and at the same time, since only the circuit board is enclosed in the shield case, the shield case can be advantageously downsized and reduced in weight to be assembled to a composite apparatus such as a television receiver with a built-in disk device, and as a result, the whole composite apparatus such as the television receiver with the built-in disk device can be downsized.

The second aspect of the present invention provides a disk device according to aspect 1, wherein the shield case is fixed to the frame so as to cover either an upper area or a lower area of the driving system unit. According to this arrangement, not only the electromagnetic noise irradiated from the circuit board but also the electromagnetic noise irradiated from the driving system unit can be shielded effectively.

The third aspect of the present invention provides a disk device according to aspects 1 or 2, wherein the shield case is divided into a first shield case and a second shield case, further comprising a positioning means for positioning the first shield case and the circuit board to the frame, a first fixing means for fixing the frame and the circuit board, and a second fixing means for fixing the circuit board and the first shield case, the first and second fixing means fixing the circuit board and the first shield case to the frame, and the second shield case being fixed to the first shield case fixed to the frame, so that the first and second shield cases enclose the circuit board. According to this arrangement, it becomes possible to omit the shield case and fix the circuit board alone on the frame of the disk device, thus enabling the frame and the circuit board of the disk device to be used in common both in a composite machine such as a television receiver with a built-in disk device and in a dedicated stand-alone disk device. Thus, the present disk device has superior versatility.

1. A disk device comprising a turntable for rotating a disk, a clamper opposed to the turntable and holding the disk therebetween, a pickup lens for irradiating a laser beam to a recording surface of the disk, a circuit board for controlling the disk device, and a frame to which the components are assembled, wherein the disk is moved from an exterior of the frame where the disk can be exchanged to an interior of the frame where the disk is opposed to the pickup lens for recording and reproducing data on the disk;
wherein the frame comprises a pair of opposing side wall portions, and a supporting unit bridged between the two side wall portions and extended in the horizontal direction for fixing a driving system unit including the pickup lens, a transport mechanism thereof and a turntable;
the disk device further comprising a shield case for enclosing the circuit board, the shield case being bridged between the side wall portions substantially in parallel with the supporting unit of the frame.

2. The disk device according to claim 1, wherein the shield case is fixed to the frame so as to cover either an upper area or a lower area of the driving system unit.

3. The disk device according to claim 1, wherein the shield case is divided into a first shield case and a second shield case, further comprising a positioning means for positioning the first shield case and the circuit board to the frame, a first fixing means for fixing the frame and the circuit board, and a second fixing means for fixing the circuit board and the first shield case, the first and second fixing means fixing the circuit board and the first shield case to the frame, and the second shield case being fixed to the first shield case fixed to the frame, so that the first and second shield cases enclose the circuit board.

4. The disk device according to claim 2, wherein the shield case is divided into a first shield case and a second shield case, further comprising a positioning means for positioning the first shield case and the circuit board to the frame, a first fixing means for fixing the frame and the circuit board, and a second fixing means for fixing the circuit board and the first shield case, the first and second fixing means fixing the circuit board and the first shield case to the frame, and the second shield case being fixed to the first shield case fixed to the frame, so that the first and second shield cases enclose the circuit board.
